(19) United States
(12) Patent Application Publication
(10) Pub. No.: US 2014/0261999 A1
(43) Pub. Date: Sep. 18, 2014

(54) METHOD OF SEPARATING AN ATOMICALLY THIN MATERIAL FROM A SUBSTRATE

(71) Applicant: LOCKHEED MARTIN CORPORATION, BETHESDA, MD (US)

(72) Inventors: John B. Stetson, JR., New Hope, PA (US); James B. Stetson, New Hope, PA (US); Stanley J. Viss, Philadelphia, PA (US)

(21) Appl. No.: 14/203,676

(22) Filed: Mar. 11, 2014

Related U.S. Application Data
(60) Provisional application No. 61/787,035, filed on Mar. 15, 2013.

(51) Int. Cl. B32B 43/00; C01B 31/04

(52) U.S. Cl. CPC B32B 43/006; C01B 31/0484
USPC 156/247; 156/705; 156/754

(57) ABSTRACT

A method of separating an atomically thin material, such as graphene, from a substrate, such as copper, is disclosed. The method provides a composite sheet, such as a graphene-copper sheet, and then applies hypersonic waves to the composite sheet so as to break the bonds therebetween and separate a graphene sheet from the copper substrate. A system to implement the separation is also disclosed.

### CROSS-REFERENCE TO RELATED APPLICATION

This application claims priority of Provisional application Ser. No. 61/787,035 filed Mar. 15, 2013 and which is incorporated herein by reference.

### TECHNICAL FIELD

Generally, the present invention is directed to preparing a sheet of atomically thin material. In particular, the present invention is directed to a method for separating an atomically thin material or sheet of such material from a supporting substrate or sheet.

### BACKGROUND ART

The ability to manipulate individual atoms for use in nanotechnology components continues to develop. Some of these developments are in the field of materials and specifically atomically thin materials which may use a single molecular component or selected combinations of molecular components. One example of such a material is graphene which is a two-dimensional aromatic carbon polymer that has a multitude of applications ranging from electronic memory, electrical storage, composite enhancement, membranes and the like.

A graphene membrane is a single-atomic-layer-thick layer of carbon atoms, bound together to define a sheet. The thickness of a single graphene membrane, which may be referred to as a layer or a sheet, is approximately 0.2 to 0.3 nanometers (nm) thick, or as sometimes referred to herein “thin.” In some embodiments, multiple graphene layers can be formed, having greater thickness and correspondingly greater strength. Multiple graphene sheets can be provided in multiple layers as the membrane is grown or formed. Or multiple graphene sheets can be achieved by layering or positioning one graphene layer on top of another. For all the embodiments disclosed herein, a single layer of graphene or multiple graphene layers may be used and are considered to be atomically thin materials. Testing reveals that multiple layers of graphene maintain their integrity and function as a result of self-adhesion. In most embodiments, the graphene membrane may be 0.5 to 2 nanometers thick. The carbon atoms of the graphene layer define a repeating pattern of hexagonal ring structures (benzene rings) constructed of six carbon atoms, which form a honeycomb lattice of carbon atoms. An interstitial aperture is formed by each six carbon atom ring structure in the sheet and this interstitial aperture is less than one nanometer across. Indeed, skilled artisans will appreciate that the interstitial aperture is believed to be about 0.23 nanometers across at its longest dimension. Accordingly, the dimension and configuration of the interstitial aperture and the electron nature of the graphene precludes transport of any molecule across the graphene's thickness.

Recent developments have focused upon graphene membranes for use as filtration membranes in applications such as salt water desalination. One example of such an application is disclosed in U.S. Pat. No. 8,361,321 which is incorporated herein by reference. As these various uses of graphene and other atomically thin materials develop, there is a need to manufacture relatively large area graphene sheets for use in filtration applications and other uses.

One way for producing graphene sheets or layers calls for chemical vapor deposition of a suitable carbon source onto a thin copper sheet. As best seen in FIG. 1, a copper sheet 10 is provided in an appropriate chamber whereupon a source of carbon 12 is processed so as to generate a vapor 14 from a carbon vapor deposition (CVD) device 16 in a controlled environment. Accordingly, as seen in FIG. 2, by controlling the parameters of the deposition process a graphene crystal lattice in conjunction with elevated temperature, about 800° centigrade, may produce a continuous graphene sheet 18 on a surface of the copper sheet 10 exposed to the vapor 14. Control of the deposition process may produce a single atomic layer of graphene or multiple atomic layers of graphene. In any event, upon completion of the vapor deposition process, a composite graphene-copper sheet designated generally by the numeral 20 is formed. The sheet 20 may also be referred to as a layered construction. The composite sheet 20 then comprises the graphene sheet 18 and the copper sheet 10. A bond 24 is developed during the deposition process between the carbon and copper atoms of sheets 10 and 18 and is considered to be a Van der Waals interaction or force. These bonding forces are of the first order and can be represented by a distributed non-linear spring stiffness.

Current methods require separation of the graphene from the copper without damaging the graphene sheet. Current separation methods literally dissolve the copper sheet 10 by using etch solutions and thereafter rendering the graphene sheet on the liquid surface of the etch vessel. Subsequent rinsing and drying of the graphene sheet is required to prepare it for its intended application. It will be appreciated that the process steps required to dissolve the copper and handle the resulting waste is expensive and time consuming. Therefore, there is a need in the art for a low cost and scalable means to safely and reliably release an atomically thin material from a substrate and in particular a graphene sheet from a copper substrate or sheet.

### SUMMARY OF THE INVENTION

In light of the foregoing, it is a first aspect of the present invention to provide a method of separating an atomically thin material from a substrate.

It is another aspect of the present invention to provide a method of separating an atomically thin material from a substrate, comprising providing an atomically thin material and a substrate that forms a composite sheet, and applying hypersonic waves to the composite sheet so as to separate the atomically thin material from the substrate.

It is an aspect of the above embodiment to use graphene for the atomically thin material and a substrate which comprises copper which are bonded to each other by bonding forces.

It is a further aspect of the above embodiment to provide for moving either the composite sheet or a hypersonic wave source that generates the hypersonic waves relative to the other.

It is yet another aspect of the above embodiment to provide a single atomic layer of graphene as part of the composite sheet. The method may also include adjusting a frequency and/or amplitude of the hypersonic waves so as to optimize separation of the composite sheet. And the method may include adjusting the frequency to about 6 Terahertz.

It is still another aspect of the above embodiment to provide a plurality of atomic layers of graphene as part of the composite sheet. The method may also include adjusting a frequency and/or amplitude of the hypersonic waves so as to optimize separation of the composite sheet. And the method may include adjusting the frequency to about 2 Terahertz.

Another aspect of the above embodiment is to provide for collecting the atomically thin material after separation with a vacuum chuck.

Still another aspect of the above embodiment is to provide for collecting the atomically thin material after separation with a take-up reel.

It is still another aspect of the invention to provide a method for separating an atomically thin material from a substrate, comprising providing a composite sheet which has an atomically thin layer bonded to a substrate, determining a bond energy value between the atomically thin material and the substrate, determining a spatial derivative value of the bond energy value, determining an equilibrium displacement valve from the spatial derivative value, and applying an excitation frequency to the composite sheet which is greater than the equilibrium displacement value.

Yet another aspect of the above embodiment is to provide the composite sheet with an atomically thin layer of graphene bonded to the substrate which comprises copper.

Still another aspect of the above embodiment is to generate the excitation frequency with a hypersonic wave source. The method may include adjusting a frequency and/or amplitude of the hypersonic waves generated by the hypersonic wave source so as to optimize separation of the atomically thin layer from the substrate. The method may provide adjusting the frequency between about 2 Terahertz to about 6 Terahertz. And the method may include moving either the hypersonic wave source or the composite sheet relative to each other.

It is another aspect of the invention to provide a system for separating an atomically thin material from a substrate comprising a hypersonic wave source positioned proximal either the atomically thin material or the substrate so as to generate hypersonic waves to separate the atomically thin material from the substrate.

Another aspect of the above embodiment is to provide the system with a source carrier which positions the hypersonic wave source in the relation to the atomically thin material and the substrate and/or a conveyor which supports the atomically thin material and the substrate in relation to the hypersonic wave source. In a further variation of the system a vacuum chuck may be used to further separate the atomically thin material from the substrate after application of the hypersonic waves by the hypersonic wave source.

### BRIEF DESCRIPTION OF THE DRAWINGS

These and other features and advantages of the present invention will become better understood with regard to the following description, appended claims, and accompanying drawings. The figures may or may not be drawn to scale and proportions of certain parts may be exaggerated for convenience of illustration.

FIG. 1 is a prior art schematic depiction of formation of a graphene-copper sheet;

FIG. 2 is a prior art schematic representation of a graphene-copper sheet according to the prior art;

FIG. 3 is a schematic representation of a process for separating an atomically thin material and a substrate from each other according to the concepts of the present invention; and

FIG. 4 shows graphical representations of bond energy (top graph) and bond force (bottom graph) as a function of a distance between an exemplary atomically thin material, such as graphene, and a substrate material, such as copper so as to illustrate when a bond between the two is released according to the concepts of the present invention.

### BEST MODE FOR CARRYING OUT THE INVENTION

As described above, the prior art methodology provides for the formation of a graphene sheet on a layer of substrate of cooper. However, the disclosure that follows is applicable to any atomically thin layer or layers of material that are formed on or bonded to a substrate that serves as a carrier. As such, the sheet 10 may be a copper material, any copper alloy, or any material upon which an atomically thin layer of material may be deposed, deposited or otherwise situated upon. Moreover, the sheet 10 may be treated with any type of chemical or other material that facilitates the bonding and/or separation process. The sheet 18 may be graphene, few-layer graphene, or any material which be deposed, deposited or otherwise formed on the substrate, wherein the bond 24 may be a Van der Waals interaction or force. Other types of atomically thin materials that may be disposed or formed on a substrate and require separation therefrom by the methods disclosed herein may include but are not limited to: molybdenum disulfide, boron nitride, hexagonal boron nitride, niobium diselenide, silicene, and germanene. As used herein, the phrase atomically thin material refers to a material that has a thickness of a least a single atom and may, in certain embodiments, may have a thickness of up to 20 atoms of the material.

As best seen in FIG. 3, a process or system for separating an atomically thin material from a substrate, wherein the material may be graphene or the like and the substrate may be copper or the like, from each other is designated generally by the numeral 26. Skilled artisans will appreciate that a bond designated generally by the numeral 24 schematically represents Van der Waals bonding forces that are in a class that can be represented by a distributed non-linear strength stiffness. Additionally, both the substrate in the form of the sheet 10 and the atomically thin material in the form of the sheet 18 can be represented as a distributed mass.

The material-substrate sheet 20, which may also be referred to as a graphene-copper sheet, is positioned so as to be in operable relationship with a hypersonic source 30. As used herein, hypersonic relates to generation of a frequency of electrical charge variation that is far above the atmospheric sonic transport velocity. The hypersonic source 30 may be moved by a source carrier 32 in a lateral, vertical or any other direction in relation to the material-substrate sheet 20. The hypersonic source 30 generates hypersonic waves and in particular a hypersonic electro-mechanical excitation frequency 34 that is arranged across one side of the graphene-copper sheet 20. In some embodiments, in order to obtain the release of a single layer of graphene from a copper substrate, the source generates an electric charge-induced force of 6×10¹² cycles per second (6 THz)+/−4×10³ cycles per second is required. In other embodiments, the release of few-layer graphene (2 to 3 layers of graphene) from a copper substrate may be accomplished by an electric charge-induced force of 2×10¹² cycles per second (2 THz)+/−2×10³ cycles per second. It is believed that similar frequency values and ranges may be employed for other types of atomically thin materials and associated substrates.

The excitation frequency 34 is tuned to be in resonance with the aforementioned mass-spring-mass system (the material-substrate sheet) consisting of the material-bond-substrate (copper-bond-graphene) system. The hypersonic source 30 may be positioned on either side of the sheet 20 by the source carrier 32. However, it is believed that the positioning of the source 30 proximal the atomically thin material sheet 18 will provide the best results. As skilled artisans will appreciate, the hypersonic source 30, which is an electrostatic device, creates an oscillatory force on the atomically thin material to drive it into resonant release from the substrate. In one embodiment, the source may be positioned above the graphene lamina at altitudes commensurate with the following scalar equation: F=qE where F is the required force (that is periodic) on the conductive graphene layer or lamina. As used in the equation, F is equal to the product of the surface charge, q and the imparted electric field, E (that is periodic). The imparted electric field, E is an inverse square function of the distance from the graphene layer or lamina; ie (E=a/x²) where x is the distance (in meters) that the exciting electrode is displaced away from the graphene layer or lamina (this is shown in FIG. 4 and discussed below). The exciting electrode distance can be larger (allowing greater physical motion of the graphene lamina) if the applied voltage V is larger, thus there is a range of feasible and practical displacements that can be adjusted for the given graphene mass density to perfect the resonant separation event. Typical values practical in an embodiment consistent with the embodiments disclosed herein are 0.1 to 1 millimeter (1×10⁻³ m) away from the graphene layer or lamina. Accordingly, in the case of graphene and copper composite sheet 20, positioning the source 30 near the graphene is more effective as the carbon atoms are easier to excite than the copper atoms.

As the sheet 20 is drawn across the hypersonic source 30 in a controlled and regulated manner by a conveyor 36, the resonant displacement normal to the sheet surfaces is generated between the material and the substrate. In most embodiments, the conveyor 36 pulls or draws the sheet 20 past the source 30. In some embodiments, the conveyor 36 may also be used to adjust the distance between the sheet 20 and the source 30. Moreover, the source 30 and the sheet 20 may each be independently moved to initiate separation. Or the source 30 and the sheet 20 may be moved by the carrier 32 and the conveyor 36 in a coordinated manner to initiate separation. Once the resonant displacement extends pass the third order Van der Waals radius (approximately 25×10⁻⁶ m), the bond strength (or the equivalent spring stiffness) essentially vanishes. Generation of the hypersonic wave creates an asymmetric force field at the bond 24. In any event, the force field breaks the Van der Waals bonds between the material 18 and the sheet 10. In the embodiment shown, the bonds between the carbon and copper are broken while leaving the carbon-carbon bonds of the graphene intact. In some embodiments, the approximate excitation frequency 34 is about 6 THz for single layer graphene and about 2 THz for multi-layer graphene. Of course, these frequencies may be adjusted due to other variations in the parameters of the separation process. As a result of the applied hypersonic waves, an unattached atomically thin material sheet 40, such as graphene, is removed or separated from the substrate or sheet 10, such as copper, and captured for subsequent applications. Skilled artisans will appreciate that the frequency values used and the spacing of the source from the composite sheet are adjustable depending upon each variation of material, thickness of the material, and the type of substrate that carries the material.

After the bonds between the sheet 10 and sheet 18 are broken, each sheet may be collected and/or transferred for subsequent use by a collection system 44. In one embodiment, the copper sheet may be pulled by a take-up reel 50 which may also assist the composite sheet 20 across the hypersonic source. In one embodiment, as the graphene sheet 40 separates from the copper sheet 10, a movable vacuum chuck 54 may pick up the graphene sheet 40 and move it for further processing. In another embodiment, another take-up reel 50′ could be used to collect the graphene sheet 40.

Referring now to FIG. 4, graphical representations of the bond energy (top graph) and bond force (bottom graph) as a function of the distance between the exemplary copper sheet 10 and the exemplary graphene sheet 18 is shown. As previously discussed, the copper sheet 10 and the graphene sheet 18 are bonded to one another by molecular attraction known as Van der Waals forces. As shown in the top graph of FIG. 4, the graphene bond energy 60, which is also referred to as Van der Waals Potential, is plotted as a function of the graphene to copper displacement 62 along the x axis. Skilled artisans will appreciate that the force experiencing an energy is the spatial derivative, or spatial gradient of the energy. A force 64, which is shown in the bottom graph of FIG. 4, represents this spatial derivative and is plotted as a function of the graphene to copper displacement 62. An equilibrium displacement 66 where the bond energy slope is zero corresponds to where an equilibrium bond force 68 is zero. At the location where the excitation frequency 34 is imparted, the graphene sheet 18 oscillates. As the oscillatory displacement builds up to the point where the positive bond attractive force dramatically reduces with a displacement 70, the graphene is harmlessly released and collected by the vacuum chuck 54 or other appropriate device. Skilled artisans will appreciate that similar graphs with values associated with the Van der Waals Potential, displacement values, and force values can be obtained for each combination of atomically thin material and associated substrate depending upon their individual properties and their properties when joined to one another. These values may then be used to optimize the separation process.

In other words, FIG. 4 represents a qualitative but theoretically consistent depiction of the relationship between bond energy and displacement of the bonds from each other and the relationship between bond force (that is the spatial derivative or gradient of energy) that must be overcome in order to separate the graphene sheet 18 from its copper substrate 10. FIG. 4 shows that there is an important asymmetry that indicates once there is a positive valuation obtained—the graphene lamina is displaced away from the copper—the attractive force vanishes and the entire sheet 18 lifts away intact from the copper substrate 10.

Based upon the foregoing, the advantages of the present invention are readily apparent. The present disclosed process eliminates the need for a liquid phase etch, rinse, retrieval, and drying process all of which are known process steps that can introduce defects and imperfections in an atomically thin material such as a graphene sheet. Moreover, the disclosed process is environmentally friendly as no copper waste solution, or other substrate material waste is generated and the copper sheet 10 that remains after the separation process can be recycled for other uses or re-used to grow another graphene sheet thereon. The present invention is also advantageous in that the manufacturing process disclosed is easily scalable, requires little power and is tunable to accommodate for bond strength variations from temperature, pressure, and other factors. In other words, depending upon the strength of the bond between the graphene and copper, the hypersonic source can vary its generated outputs so as to ensure repeatable separation of the graphene layer from the copper sheet. Moreover, the hypersonic source can be adapted to separate other atomically thin materials from an associated substrate material.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of separating a composite sheet which includes an atomically thin material and a substrate, comprising:
applying hypersonic waves to the composite sheet so as to separate the atomically thin material from the substrate.

2. The method according to claim 1, further comprising:
forming the composite sheet from a graphene sheet and a copper sheet which are bonded to each other by bonding forces.

3. The method according to claim 1, further comprising:
moving one of the composite sheet and a hypersonic wave source that generates said hypersonic waves relative to the other.

4. The method according to claim 1, further comprising:
providing a single atomic layer of graphene as part of the composite sheet.

5. The method according to claim 4, further comprising:
adjusting a frequency and/or amplitude of said hypersonic waves so as to optimize separation of the composite sheet.

6. The method according to claim 5, further comprising,
adjusting said frequency to about 6 Terahertz.

7. The method according to claim 1, further comprising:
providing a plurality of atomically thin layers of graphene as part of the composite sheet.

8. The method according to claim 7, further comprising:
adjusting a frequency and/or amplitude of said hypersonic waves so as to optimize separation of the composite sheet.

9. The method according to claim 8, further comprising,
adjusting said frequency to about 2 Terahertz.

10. The method according to claim 1, further comprising:
collecting the atomically thin material after separation with a vacuum chuck.

11. The method according to claim 1, further comprising:
collecting the atomically thin material after separation with a take-up reel.

12. A method for separating an atomically thin material from a substrate, comprising:
providing a composite sheet which has an atomically thin layer bonded to a substrate;
determining a bond energy value between said atomically thin material and said substrate;
determining a spatial derivative value of said bond energy value;
determining an equilibrium displacement valve from said spatial derivative value; and
applying an excitation frequency to said composite sheet which is greater than said equilibrium displacement value.

13. The method according to claim 12, further comprising:
providing said composite sheet with an atomically thin layer of graphene bonded to said substrate which comprises copper.

14. The method according to claim 12, further comprising:
generating said excitation frequency with a hypersonic wave source.

15. The method according to claim 14, further comprising:
adjusting a frequency and/or amplitude of hypersonic waves generated by said hypersonic wave source so as to optimize separation of said atomically thin layer from said substrate.

16. The method according to claim 15, further comprising:
adjusting said frequency between about 2 Terahertz to about 6 Terahertz.

17. The method according to claim 16, further comprising;
moving said hypersonic wave source relative to said composite sheet.

18. The method according to claim 16, further comprising;
moving said composite sheet source relative to said hypersonic wave.

19. A system for separating an atomically thin material from a substrate, comprising:
a hypersonic wave source positioned proximal either the atomically thin material or the substrate so as to generate hypersonic waves to separate the atomically thin material from the substrate.

20. The system according to claim 19, further comprising:
a source carrier which positions said hypersonic wave source in relation to the atomically thin material and the substrate.

21. The system according to claim 19, further comprising:
a conveyor which supports and positions the atomically thin material and the substrate in relation to the hypersonic wave source.

22. The system according to claim 19, further comprising:
a source carrier which positions said hypersonic wave source in relation to the atomically thin material and the substrate; and
a conveyor which supports and positions the atomically thin material and the substrate in relation to said hypersonic wave source.

23. The system according to claim 22, further comprising:
a vacuum chuck to lift and further separate the atomically thin material from the substrate after application of the hypersonic waves by said hypersonic wave source.
